(19) United States
(12) Patent Application Publication
(10) Pub. No.: US 2025/0138151 A1
(43) Pub. Date: May 1, 2025

(54) GHOSTING PROCESSING METHOD

(71) Applicant: JORJIN TECHNOLOGIES INC., New Taipei City (TW)

(72) Inventors: JIUN-SHIANG SHIU, New Taipei City (TW); MING-TE YU, New Taipei City (TW)

(21) Appl. No.: 18/884,433

(22) Filed: Sep. 13, 2024

(30) Foreign Application Priority Data
Oct. 30, 2023 (TW) 112141497

(51) Int. Cl. G01S 7/41; G01S 13/42

(52) U.S. Cl. CPC G01S 7/414; G01S 13/426

(57) ABSTRACT

A ghosting processing method is used with a radio wave radar sensor for monitoring a designated area. The ghosting processing method includes steps of: emitting a radio wave signal to the designated area wherein the radio wave signal is reflected by the designated area; receiving and processing the reflected radio wave signal from the designated area to generate first point cloud distribution data; and performing a ghosting removal calculation based on the first point cloud distribution data and at least one predefined exception zone to generate second point cloud distribution data.

### FIELD OF THE INVENTION

The present disclosure relates to a ghosting processing method, and particularly to a ghosting processing method used with a radio wave radar sensor for monitoring a designated area.

### BACKGROUND OF THE INVENTION

Millimeter waves (mm Wave) usually refer to electromagnetic waves with wavelengths of 1˜10 mm, and the corresponding frequency band of millimeter waves is 30˜300 GHz. A millimeter-wave radar sensor can emit millimeter waves through an antenna and receive signals reflected back from the target. Through calculation, the distance, angle, and relative speed of the target with respect to the millimeter-wave radar can be obtained. This sensing technology has wide applications in many fields. The millimeter-wave radar sensors have advantages of excellent resolution, accurate target detection/tracking performance and good distinguishability for different targets. Therefore, the millimeter-wave radar sensors have many applications, e.g. object detection, target recognition, indoor mapping and indoor navigation.

However, the millimeter-wave radar sensors still need to be improved. For example, when a person is passing through the monitored area, ghosts may occur due to improper refraction or reflection from the surrounding environment (e.g. glass or metal surfaces with high reflectivity) and such phenomenon will cause errors in data interpretation. It is desired to overcome this problem.

### SUMMARY OF THE INVENTION

An aspect of the present disclosure provides a ghosting processing method used with a radio wave radar sensor for monitoring a designated area. At first, a radio wave signal is emitted to the designated area wherein the radio wave signal is reflected by the designated area. Then, the reflected radio wave signal from the designated area is received and processed to generate first point cloud distribution data. Subsequently, a ghosting removal calculation based on the first point cloud distribution data and at least one predefined exception zone is performed to generate second point cloud distribution data.

In an embodiment, the radio wave radar sensor is a millimeter-wave radar sensor, and the radio wave signal is a millimeter wave signal.

In an embodiment, the predefined exception zone is represented by a preset coordinate data file wherein it is judged that an appearance of a person in the predefined exception zone in the designated area is impossible.

In an embodiment, the ghosting processing method further includes a step of performing a logical operation of the first point cloud distribution data and the preset coordinate data file to eliminate point cloud data which are corresponding to the predefined exception zone and viewed as a ghost, thereby generating the second point cloud distribution data with the ghost removed.

In an embodiment, the preset coordinate data file representing the predefined exception zone is obtained by converting a layout blueprint of the designated area.

In an embodiment, the preset coordinate data file representing the predefined exception zone is obtained by using the radio wave radar sensor to scan objects in the designated area in advance.

In an embodiment, the radio wave radar sensor scans the objects in the designated area for a designated time period in advance.

In an embodiment, the preset coordinate data file representing the predefined exception zone is automatically calibrated by scanning the designated area at intervals.

In an embodiment, a front-end radar module of the radio wave radar sensor emits the radio wave signal to the designated area, and receives the reflected radio wave signal from the designated area. A detection layer module of the radio wave radar sensor generates the first point cloud distribution data according to the reflected radio wave signal, and performs the ghosting removal calculation based on the first point cloud distribution data and the predefined exception zone to generate the second point cloud distribution data.

In an embodiment, the ghosting processing method further includes steps of: calculating a quantitative percentage of reflection points located within the predefined exception zone when not all reflection points of one point cloud are located within the predefined exception zone; determining that the one point cloud is a ghost and entirely removing the one point cloud if the quantitative percentage exceeds a preset percentage; and determining that the one point cloud is not a ghost and retaining the one point cloud if the quantitative percentage does not exceed the preset percentage.

### BRIEF DESCRIPTION OF THE DRAWINGS

The advantages of the present disclosure will become more readily apparent to those ordinarily skilled in the art after reviewing the following detailed description and accompanying drawings, in which:

FIG. 1A is a flowchart showing a ghosting processing method according to an embodiment of the present disclosure.

FIG. 1B is a schematic diagram illustrating the ghosting processing method used for monitoring a designated area.

FIG. 2 is a functional block diagram illustrating a millimeter-wave radar sensor which can perform real-time people tracking and counting in a three-dimensional space according to the present disclosure.

### DETAILED DESCRIPTION OF PREFERRED EMBODIMENTS

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed. The figures do not necessarily reflect the actual structure of components being illustrated. Modifications or adjustments should be covered in the practicable scope of the present disclosure when such changes do not deviate from the concepts of the present disclosure.

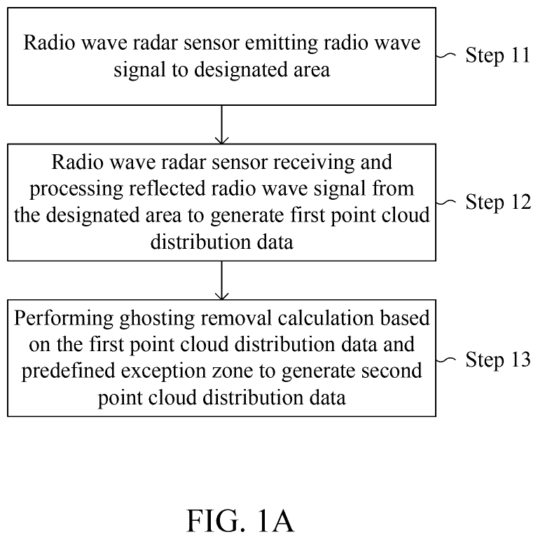

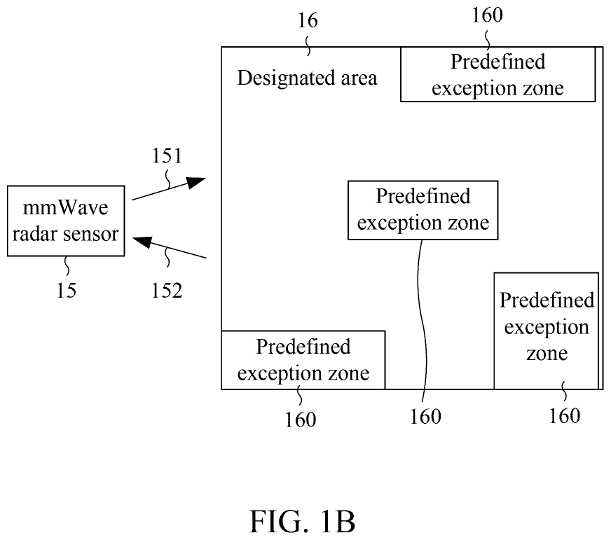

Please refer to FIG. 1, which is flowchart showing a ghosting processing method according to an embodiment of the present disclosure. The ghosting processing method is used with a radio wave radar sensor for monitoring a designated area. The ghosting processing method basically includes the following steps. At first, the radio wave radar sensor emits a radio wave signal to the designated area (Step 11). Then, the radio wave radar sensor receives and processes the reflected radio wave signal from the designated area to generate first point cloud distribution data (Step 12). Subsequently, a ghosting removal calculation is performed based on the first point cloud distribution data and a predefined exception zone to generate second point cloud distribution data (Step 13). In an embodiment, the radio wave radar sensor is a millimeter-wave radar sensor, the radio wave signal is a millimeter wave signal, and the designated area is an indoor space such as a conference room, a company lobby or a shopping mall hall. A schematic diagram of the exemplified arrangement for monitoring a designated area is shown in FIG. 1B. A millimeter-wave radar sensor 15 transmits a millimeter wave signal 151 to the designated area 16. Then, the millimeter wave signal 151 is reflected by objects located in the designated area 16 and the millimeter-wave radar sensor 15 receives and processes the reflected radio wave signal 152 to generate first point cloud distribution data. Subsequently, the method of the present disclosure performs a ghosting removal calculation based on the first point cloud distribution data and at least one predefined exception zone 160 to generate second point cloud distribution data. The predefined exception zone is not limited to one but also multi-zones.

For example, the millimeter-wave radar sensor 15 in this case is to perform real-time positioning, tracking and monitoring of people appearing in the designated area 16. The millimeter wave signal 151 may be improperly refracted or reflected due to the surrounding environment to generate ghost point cloud(s). Such data causes misjudgments in the number of people and real-time positioning/tracking. In order to reduce the influence caused by ghosting, the present disclosure provides concepts of considering predefined exception zones. The exception zones are where people should not appear and represented by a preset coordinate data file. The preset coordinate data file could be a two-dimensional coordinate data file or a three-dimensional coordinate data file, which defines a plane space or a three-dimensional space where people in the designated area 16 seem unlikely to be located.

Therefore, the point cloud data corresponding to the predefined exception zone(s) 160 could be viewed as ghost(s) and are eliminated by a logical operation (e.g. AND operation) of the preset coordinate data file and the first point cloud distribution data obtained by processing the reflected radio wave signal 152, thereby generating the second point cloud distribution data with ghost(s) removed. The preset coordinate data file representing the predefined exception zone(s) could be obtained by converting the layout blueprint of the designated area 160, or using the millimeter-wave radar sensor 15 to scan objects in the designated area 16 for a designated time period in advance (e.g. within the first hour after the millimeter-wave radar sensor 15 is installed in the designated area 16 and before it starts to monitor the designated area 16). The predefined exception zone is usually corresponding to fixed furniture or structure such as conference table, cabinet or pillar. Therefore, any zone corresponding to the still three-dimensional object found in the designated area 16 could be defined as the exception zone 160 because an appearance of a person in the predefined exception zone 160 in the designated area is impossible. In another embodiment, it is also applicable to scan the designated area 16 at intervals to automatically calibrate and update the coordinate data file representing the predefined exception zone(s). In a further embodiment, the preset coordinate data file may represent a predefined normal zone contrary to the exception zone(s). The preset coordinate data file representing the normal zone could be obtained by performing simple logical conversion on the preset coordinate data file representing the exception zone(s), and no further details need to be given.

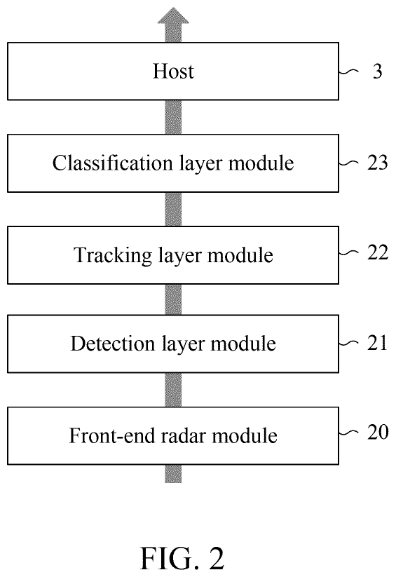

Now, we take the available hardware system resources (IWR6843 millimeter-wave radar sensor from Texas Instruments) as an example to give the details of the present disclosure. Please refer to FIG. 2, which is a functional block diagram illustrating the IWR6843 millimeter-wave radar sensor which can perform real-time people tracking and counting in a three-dimensional space according to the present disclosure. The front-end radar module 20 emits the radio wave signal to the designated area 16, and receives the reflected radio wave signal from the designated area 16. Then, the front-end radar module 20 generates and transmits analog-to-digital converter (ADC) sampling data to the detection layer module 21. The detection layer module 21 senses multiple reflections in the three-dimensional environment around the millimeter-wave radar sensor and generates set(s) of measurement vectors (e.g. point cloud(s)) which include abundant information and represent real target(s) in the three-dimensional space. Each measurement vector generated by the detection layer module 21 represents a reflection point and includes information such as distance, azimuth angle, elevation angle, radial velocity (i.e., Doppler velocity) and signal-to-noise ratio (SNR). In particular, the ghosting processing method of the present disclosure is performed by the detection layer module 21. Though the ghosting removal calculation based on the first point cloud distribution data and at least one predefined exception zone, the second point cloud distribution data with ghost(s) (i.e. the point cloud(s) corresponding to the predefined exception zone(s)) removed are generated.

In one point cloud, if all reflection points are located within the predefined exception zone, it is determined that the point cloud is a ghost and should be removed. In another case, if only some reflection points in one point cloud is located within the predefined exception zone, further consideration is required to determine whether the point cloud is a ghost.

For example, in one point cloud, a quantitative percentage of the reflection points located within the predefined exception zone is calculated. If the quantitative percentage exceeds a preset percentage (e.g. 50% or other proper percentage), it is determined that the point cloud is a ghost and will be entirely removed. Otherwise, if the quantity percentage does not exceed the preset percentage, it is determined that the point cloud is not a ghost and should be retained.

After the above ghost removal calculation, the detection layer module 21 transmits the second point cloud distribution data without ghosting to the subsequent functional block for processing. For example, the second point cloud distribution data could be transmitted to the tracking layer module 22 for positioning and tracking targets (persons) in the scene, thereby generating a target (person) list. Then, the target (person) list can be further classified by the classification layer module 23, thereby generating a classified list. The host 3 can use the information of the second point cloud distribution data, the target (person) list and the classified list to create a visual scene and target (person) real-time location map. In some embodiments, it is also possible to distinguish between motions of human and non-human which passes through the scene. Further, in the design of the millimeter-wave radar sensor, some operations could be selectively assigned to the host 3 instead of the classification layer module 23.

In conclusion, the present disclosure removes ghost point clouds in the detection results of the millimeter-wave radar sensor by defining exception zones in the designated scene or area. The present disclosure can be applied to a fixed scene. Furthermore, by predefining the exception zones in the scene, the scene can be updated regularly or flexibly, so that the mirror ghost point clouds caused by improper reflection can be quickly identified and eliminated. The ghosting processing method of the present disclosure has noticeable effect and improvement, and it is novel and inventive.

While the disclosure has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A ghosting processing method used with a radio wave radar sensor for monitoring a designated area, comprising steps of:
emitting a radio wave signal to the designated area wherein the radio wave signal is reflected by the designated area;
receiving and processing the reflected radio wave signal from the designated area to generate first point cloud distribution data; and
performing a ghosting removal calculation based on the first point cloud distribution data and at least one predefined exception zone to generate second point cloud distribution data.

2. The ghosting processing method according to claim 1, wherein the radio wave radar sensor is a millimeter-wave radar sensor, and the radio wave signal is a millimeter wave signal.

3. The ghosting processing method according to claim 1, wherein the at least one predefined exception zone is represented by a preset coordinate data file wherein it is judged that an appearance of a person in the at least one predefined exception zone in the designated area is impossible.

4. The ghosting processing method according to claim 3, further comprising a step of performing a logical operation of the first point cloud distribution data and the preset coordinate data file to eliminate point cloud data which are corresponding to the at least one predefined exception zone and viewed as a ghost, thereby generating the second point cloud distribution data with the ghost removed.

5. The ghosting processing method according to claim 3, wherein the preset coordinate data file representing the at least one predefined exception zone is obtained by converting a layout blueprint of the designated area.

6. The ghosting processing method according to claim 3, wherein the preset coordinate data file representing the at least one predefined exception zone is obtained by using the radio wave radar sensor to scan objects in the designated area in advance.

7. The ghosting processing method according to claim 6, wherein the radio wave radar sensor scans the objects in the designated area for a designated time period in advance.

8. The ghosting processing method according to claim 7, wherein the preset coordinate data file representing the at least one predefined exception zone is automatically calibrated by scanning the designated area at intervals.

9. The ghosting processing method according to claim 1, wherein a front-end radar module of the radio wave radar sensor emits the radio wave signal to the designated area, and receives the reflected radio wave signal from the designated area.

10. The ghosting processing method according to claim 9, wherein a detection layer module of the radio wave radar sensor generates the first point cloud distribution data according to the reflected radio wave signal, and performs the ghosting removal calculation based on the first point cloud distribution data and the at least one predefined exception zone to generate the second point cloud distribution data.

11. The ghosting processing method according to claim 1, further comprising steps of:
calculating a quantitative percentage of reflection points located within the predefined exception zone when not all reflection points of one point cloud are located within the predefined exception zone;
determining that the one point cloud is a ghost and entirely removing the one point cloud if the quantitative percentage exceeds a preset percentage; and
determining that the one point cloud is not a ghost and retaining the one point cloud if the quantitative percentage does not exceed the preset percentage.
